(19) United States
(12) Patent Application Publication
(10) Pub. No.: US 2023/0273335 A1
(43) Pub. Date: Aug. 31, 2023

(54) INTEGRATION OF GEOTAGS AND OPPORTUNITY MATURATION

(71) Applicant: SCHLUMBERGER TECHNOLOGY CORPORATION, Sugar Land, TX (US)

(72) Inventors: Andreas W. LAAKE, Hannover (DE); Tracy FRUGIER-DORRINGTON, Houston, TX (US)

(21) Appl. No.: 18/006,583

(22) PCT Filed: Jul. 24, 2020
(86) PCT No.: PCT/US2020/043423

§ 371 Date: Jan. 24, 2023

(51) Int. Cl. G01V 1/50; G01V 1/46

(52) U.S. Cl. CPC G01V 1/50; G01V 1/46; G01V 2210/65

(57) ABSTRACT

A method includes obtaining data representing a subterranean domain, identifying a candidate location in the subterranean domain based on the data, creating a geotag associated with the candidate location, storing metadata in association with the geotag. The metadata describes the geotag, the data at or around the location, or both. The method also includes performing an opportunity maturation process to evaluate the candidate location for selection as a well location, storing a result of the opportunity maturation process as additional metadata associated with the geotag, and selecting the candidate location as the well location based in part on the opportunity maturation process.

### BACKGROUND

In oil and gas exploration, geoscientists use paper or electronic documents to annotate their findings about a particular region or location. The findings are then correlated manually with areas of similar geologic settings thus helping them to explain the characteristics of the exploratory target. These areas of similar geologic setting are also called geologic analogs.

This traditional approach generally captures a portion of the knowledge the geoscientist may wish to save, while some is lost because of the technical constraints provided by marking the location of interest on paper or as a location in an electronic file. Furthermore, these markings may be confined to the media in which they have been prepared, e.g., to the paper document on which they were marked or within the program that has been used to generate the location information. As a result, such location notes remain inaccessible to digital search engines, which can reduce the distribution of knowledge about a particular location.

The knowledge gleaned about a particular location, which may be ever-evolving as more information is received, additional processing is conducted, etc., may be used to evaluate the likelihood of success (e.g., with success being the economical extraction of hydrocarbons from a location). However, because knowledge may not be shared and analogs may be difficult to identify, there is often a large amount of guesswork involved in establishing such a likelihood of success, which is generally considered part of the “risking” process as it is known. The guesswork, usually conducted by subject matter experts may thus have a degree of uncertainty, which may be large, but is generally unknown. Accordingly, the risking numbers may be difficult to rely on.

### SUMMARY

Embodiments of the disclosure provide a method that includes obtaining data representing a subterranean domain, identifying a candidate location in the subterranean domain based on the data, creating a geotag associated with the candidate location, and storing metadata in association with the geotag. The metadata describes the geotag, the data at or around the location, or both. The method also includes performing an opportunity maturation process to evaluate the candidate location for selection as a well location, storing a result of the opportunity maturation process as additional metadata associated with the geotag, and selecting the candidate location as the well location based in part on the opportunity maturation process.

Embodiments of the disclosure also provide a computer system including one or more processors, and a memory system including one or more non-transitory computer-readable media storing instructions that, when executed by at least one of the one or more processors, cause the computer system to perform operations. The operations include obtaining data representing a subterranean domain, identifying a candidate location in the subterranean domain based on the data, creating a geotag associated with the candidate location, and storing metadata in association with the geotag. The metadata describes the geotag, the data at or around the location, or both. The operations also include performing an opportunity maturation process to evaluate the candidate location for selection as a well location, storing a result of the opportunity maturation process as additional metadata associated with the geotag, and selecting the candidate location as the well location based in part on the opportunity maturation process.

Embodiments of the disclosure further provide a non-transitory computer-readable medium storing instructions that, when executed by at least one processor of a computing system, cause the computing system to perform operations. The operations include obtaining data representing a subterranean domain, identifying a candidate location in the subterranean domain based on the data, creating a geotag associated with the candidate location, and storing metadata in association with the geotag. The metadata describes the geotag, the data at or around the location, or both. The operations also include performing an opportunity maturation process to evaluate the candidate location for selection as a well location, storing a result of the opportunity maturation process as additional metadata associated with the geotag, and selecting the candidate location as the well location based in part on the opportunity maturation process.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a block diagram of a geotagging system, according to an embodiment.

FIG. 5 illustrates a block diagram of a system for integrating geotags with an opportunity pipeline, according to an embodiment

FIG. 6 illustrates another conceptual view of a geotag having metadata that is updated or appended as part of an opportunity maturation process, according to an embodiment.

FIG. 7 illustrates a flowchart of a method for selecting a well location from candidate locations using geotags and an opportunity maturation process, according to an embodiment.

FIG. 8 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the disclosure. However, it will be apparent to one of ordinary skill in the art that the disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the disclosure. The first object and the second object are both objects, respectively, but they are not to be considered the same object.

The terminology used in the description of the disclosure herein is for the purpose of describing particular embodiments only and is not intended to be limiting of the disclosure. As used in the description of the disclosure and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

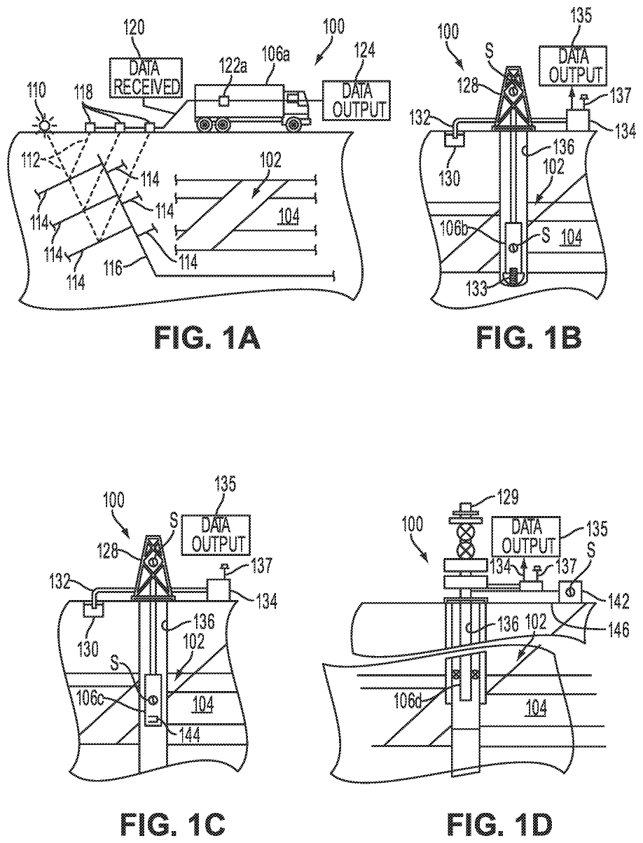

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

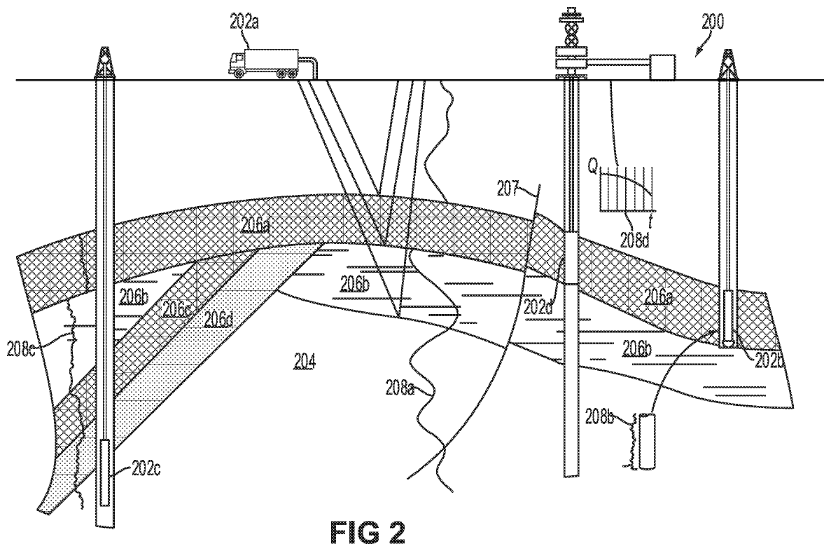

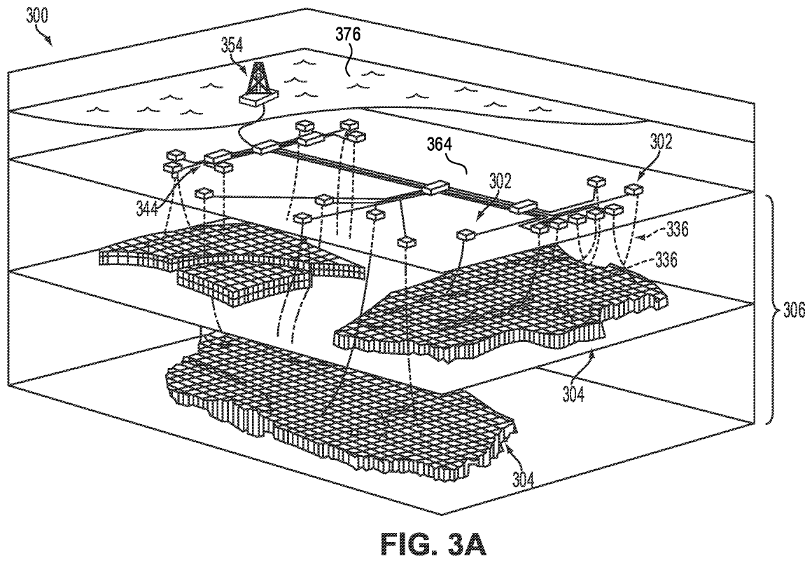

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

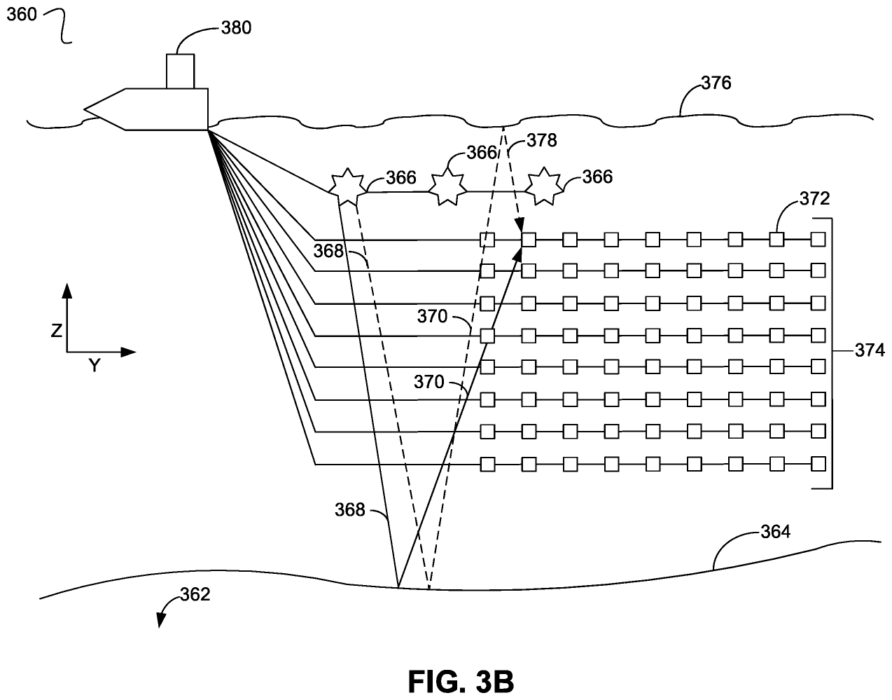

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present. In the illustrates, marine example, the environment may include a sea surface 376 and a seafloor surface 364.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the sea surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

Embodiments of the present disclosure generally include systems and methods for creating, refining, and using digital markers (“geotags”) in an oilfield exploration, drilling, and production environment. The geotags are used to store information about a location, and may be displayed as a dynamic link within a visualization of the data representing the subterranean volume of data. The geotags may be employed to capture knowledge acquired during the process of processing, analysis, interpretation, and modeling when labelling opportunities in a resource exploration workflow. These geotags are created and stored in a distributed computing (e.g., cloud-based) process by geoscientists working with data and models and may include metadata information about origin, location, and geoscientific characteristics of a spatial location in depth and geological time. The metadata may be provided by humans and/or artificial intelligence (AI) based on interpretation or by digital processes using digital processing and interpretation of the data. The amount of information and knowledge collected in the geotags increases with the maturation of the tagged location during an “opportunity maturation” process, which includes assigning risk (or conversely, a likelihood of success) to a location, whereby locations with good chances of success may develop from a candidate, to a lead, a prospect, a drilling location, or even a well location.

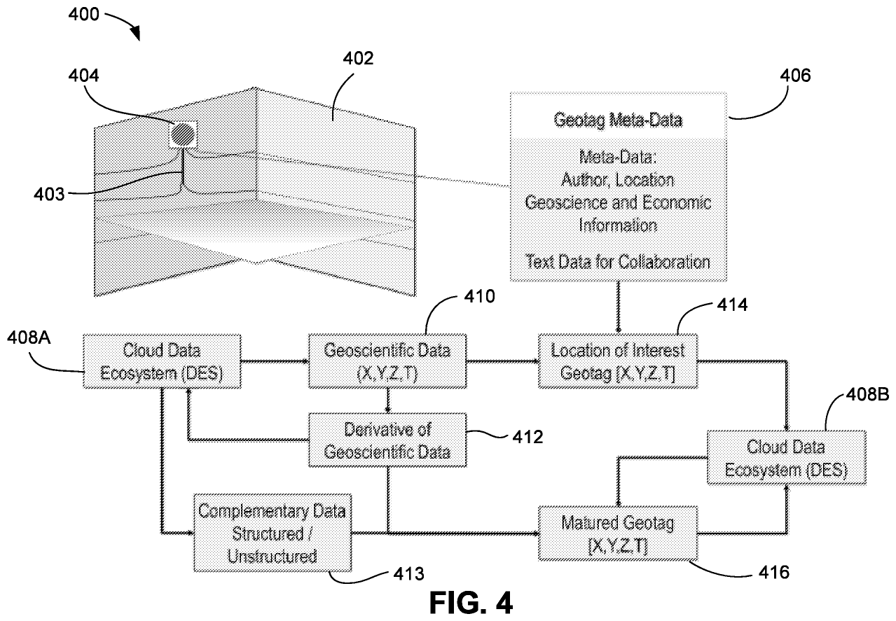

FIG. 4 illustrates a functional block diagram of a geotagging system 400, according to an embodiment. The geotagging system 400 may include data representing a subterranean volume 402. The data representing the subterranean volume 402 may be obtained from one or more of a variety of sources, including seismic, core samples, well logs, etc. The volume 402 may include one or more features 403, such as an anticline, to name one specific example. The feature 403 may indicate an area where hydrocarbons may, potentially, be located and thus may be of interest to users. Accordingly, a geotag 404 may be generated to mark the feature 403 in the volume 402.

The geotag 404 may not be a static part of the data (e.g., the image) of the volume 402. For example, the geotag 404 may be stored in a database in association with the location (which may include horizontal, depth, and/or time dimensions). In some embodiments, a larger, e.g., map-based view of an area may be available, and a user may manipulate the view until a region of interest is created on the screen, which may include subsurface regions. When the screen includes the location corresponding to the geotag 404, the geotag 404 may be displayed. As such, the geotag 404 may be stored and displayed when its location is part of the current view, e.g., within a certain resolution, etc.

The geotag 404 may, in addition to its location in the volume 402, store various metadata, as indicated at 406, e.g., in a database. This metadata 406 may at least partially describe the location of interest, even if indirectly (e.g., it may refer to the political climate of the general area in which the geotag 404 is located, industry activity in the area, economic conditions, etc.). The metadata 406 may include, for example, a name, date, location and affiliation of the author of the geotag; a location component such as coordinates, depth, corresponding geological time; a data component including a description of data set(s) and interpretation using which the geotag was generated and/or settings of analysis window at the time of creating the geotag; a petroleum system component including information regarding the petroleum system elements identified at the location of the geotag including among others source and maturation of hydrocarbons, migration pathway, reservoir, seal, trap, retention, and play; a geology component including modern and (geologically) historic structural and stratigraphic setting, geologic age, sequence stratigraphic description, lithology; a risking component including risking parameters, information about chance of success for petroleum system elements; a petroleum economics component including legislation, block/concession and operatorship, information regarding field, its development status including infrastructure, and production; and a drilling component: information regarding pressure, well planning and completion.

The geotag metadata 406 may be stored in a cloud data ecosystem (DES), which may be represented as two ecosystems 408A, 408B in this view, but may also be considered a single DES in some embodiments. The DES 408A, 408B may store the data according to various schemas in different locations throughout a computing system, e.g., on different servers that are remotely accessible, etc. The metadata 406 may be geoscientific data 410 and may be stored according to coordinates within the volume 402, e.g., X, Y, Z (depth), and/or T (time). Derivatives 412 of the geoscientific data 410 may be developed, e.g., through processing techniques, which permit additional information, inferences, etc. about the subterranean volume 402 to be made. These derivatives 412 may be stored in the DES 408A. Further, complementary data 413, which may be structured (e.g., spreadsheets or forms) or unstructured (e.g., text-based) may be stored in the DES 408A. In some cases, text-based data may be added by human users as interpretation notes that can inform later processing, decision-making, etc.

At some point, a user may initialize a geotag 404 at a location of interest 414, as generally described above. The location of interest may be at a feature, e.g., the feature 403, as mentioned above. The location of interest may thus have a coordinate in the volume 402, e.g., X, Y, Z, and/or T coordinates, corresponding to the location of the feature 403. The geotag 404 and any metadata 406 associated therewith may thus be stored in the DES 408B for later use, e.g., through searching, as will be described in greater detail below. In addition, a matured geotag 418 may also be produced and stored, e.g., by refining the information stored in combination with the geotag 404, e.g., during or after an opportunity maturation processes, as will be described in greater detail below. Accordingly, the geotags 404 may be iteratively searched, accessed, updated, clustered, split, and otherwise manipulated.

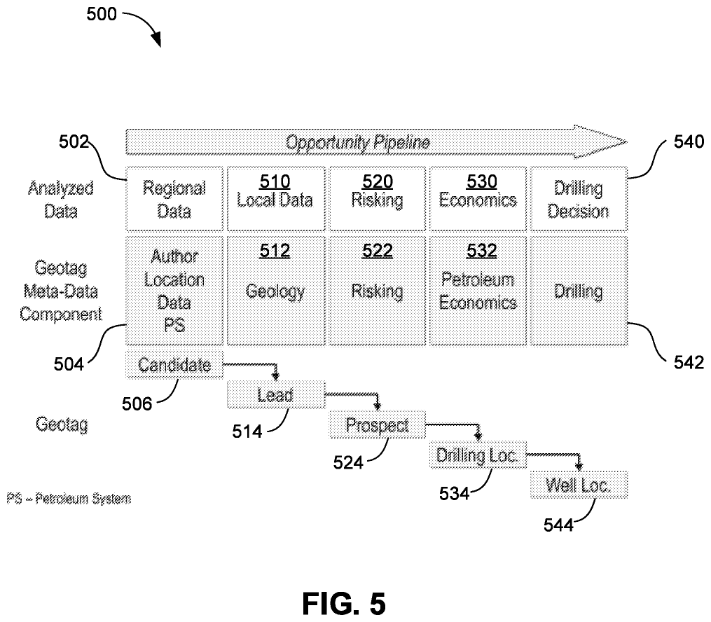

FIG. 5 illustrates a block diagram of a system 500 for integrating geotags with an opportunity pipeline, according to an embodiment. An opportunity pipeline generally describes the maturation process during which a well site is selected from among many potential candidates, researched and analyzed, and ultimately determined to be viable and then drilled, completed, and produced. Geotags may be useful in this process to assist in the risking process, as analogs of locations (e.g., in geological, structural, drilling, environmental, political, etc. senses) may be analyzed and the risking derived based on risking that was previously completed for these other, analogous locations.

Accordingly, the opportunity pipeline may begin by analyzing regional data, as at 502, e.g., in order to identify features in the subsurface that may be indicative of the presence of hydrocarbons. Geotags may be initiated, e.g., based on features identified in the regional data, and metadata 504 associated with the geotags may be updated/appended using the regional data. The metadata 504 may include author, location, data, and petroleum system. The metadata 504 may be employed to rule out locations that are not of interest, e.g., noise in the data, locations that have already been rejected and should not be reconsidered, etc. Locations that remain of interest may be candidates 506, which have geotags associated therewith, as shown.

The system 500 may consider many candidates 506, e.g., hundreds, thousands, or more, and thus the regional data 502 and metadata 504 associated with geotags therein may be employed to quickly winnow down the number of candidates 506, e.g., ruling out candidates that may not be worth additional analysis. It will be appreciated, however, that these candidates 506 may not be discarded, as changing information make change the value of the candidates 506 at a later time. To do this, the system 500 may consider local (e.g., geologic) data, as at 510, and with results thereof describing the geology of the candidates 506 and being stored in metadata as at 512. The system 500 may also search through a database of geotags to identify analogs that may inform the opportunity maturation process, as will be described in greater detail below. If the geologic information of the local geotags, along with what is known about the location of interested associated with a lead geotag, indicates that the candidate location has favorable conditions, e.g., for the storage of hydrocarbons, the candidate may be upgraded to a lead at 514; otherwise, the candidate 506 may be ruled out or otherwise discarded, and any geotags associated therewith may be updated to include that the candidate 506 was ruled out.

The leads 516 may be evaluated based on a risking analysis, as at block 520. The risking analysis 520 may gather available information about the location of interest, along with any information known about analogous locations from searching through the geotags, including previously calculated risking for those analogous locations (e.g., in a database of geotags), which is stored in association with the geotags for the analogous locations, as indicated at 522. The risking analysis 520 may then be applied to the prospect to establish a quantitative risk that drilling, production, etc., is ultimately unsuccessful (e.g., no economically-produced hydrocarbons). If the risk value applied by the risking analysis above a risk-tolerance threshold, the lead 514 may be discarded. Otherwise, the lead 516 may be considered as a prospect 524.

The prospects 524 may be evaluated based on economics, as at 530. This may include a multitude of factors, including the drilling/production equipment that is usable for the location 530, amount of hydrocarbons thought to be present in the reservoir, as well as the transportation costs for the particular prospect 524, and treatment/injection process that may be prescribed as part of a plan to drill the well at the prospect 524. The metadata of analogous geotags may also be considered, especially the petroleum system elements and economics components thereof. There result of the economic analysis (including analogous geotags) may be stored as metadata at 532. If a prospect 524 is found to be economically viable, it may be considered for a drilling location 534.

Drilling locations 534 may be evaluated to make a drilling decision, as at 540. Drilling data, e.g., well plans, geometry, rig equipment, etc., may be obtained, and considered in view of the data about the subterranean area and/or for analogous geotags, as at 532. Once a drilling location 534 is selected, a well may be constructed, completed, produced, and eventually abandoned as part of its lifecycle. The geotag(s) associated with the well location may be updated along the way, such that subsequent well locations may be selected from among thousands of candidates based on the same or similar process.

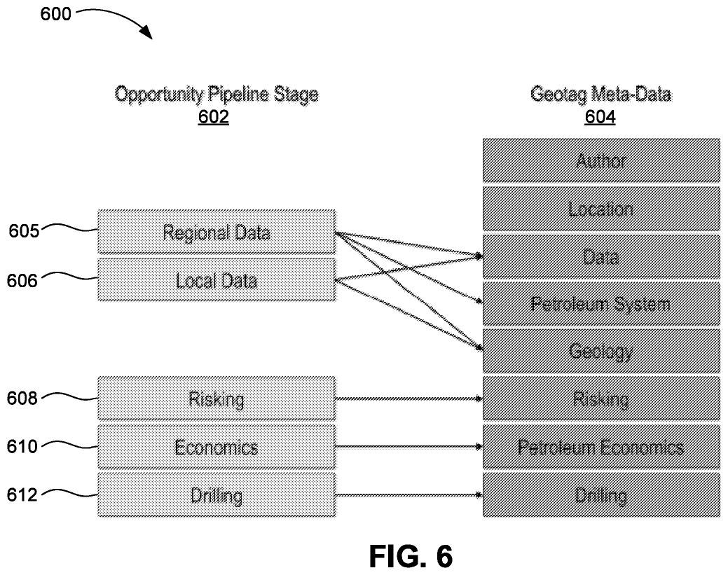

FIG. 6 illustrates a conceptual view of a system 600 that integrates the geotags with the opportunity maturation process (also referred to as an “opportunity pipeline”), according to an embodiment. In particular, the system 600 illustrates building and updating geotag metadata 602 during respective opportunity pipeline stages 602. For example, the geotag metadata 602 may be initialized with data fields for author, location, data, petroleum system, geology, risking, petroleum economics, and drilling, as shown. As this information becomes known or refined, it may be added to the geotag metadata 602 in a manual or automated process. For example, author and location may be readily available at initialization. Next, as regional data is collected (e.g., to analyze a candidate, as discussed above) at 605, the regional data may be added to the data fields, petroleum system fields, and/or geology fields, as shown. Likewise, as local data 606 becomes available (e.g., to identify a lead from a candidate), the local data may be added to the data, petroleum system, and/or geology fields, as appropriate.

When the risking is completed at 608, e.g., for finding a prospect from a lead, the risking analysis or results thereof (e.g., a risk value) may be stored in the risking field. Economics data 610, collected when identifying a drilling location from a prospect, may be stored in the petroleum economics field. Drilling data 612, collected while drilling a well, may be stored in the drilling field while or after creating a well location. Accordingly, each step in the opportunity maturation process may reveal additional metadata about a particular location, which may or may not affect the geographic representation of subterranean location associated with the geotag; however, it may be useful for subsequent evaluation of similar locations. Accordingly, by storing the geotags in a database in association with the metadata 604, this metadata 604 may be searched to assist in subsequent processes, e.g., risking, drilling decisions, etc., as they indicate what was done in other instances. It will be appreciated that the entire process of the opportunity pipeline may not be conducted for each tag, and likely would not be. Rather, the data acquired for a geotag may be stored in association therewith in an effort to provide additional data, even if the entirety of the metadata is not complete for a given geotag.

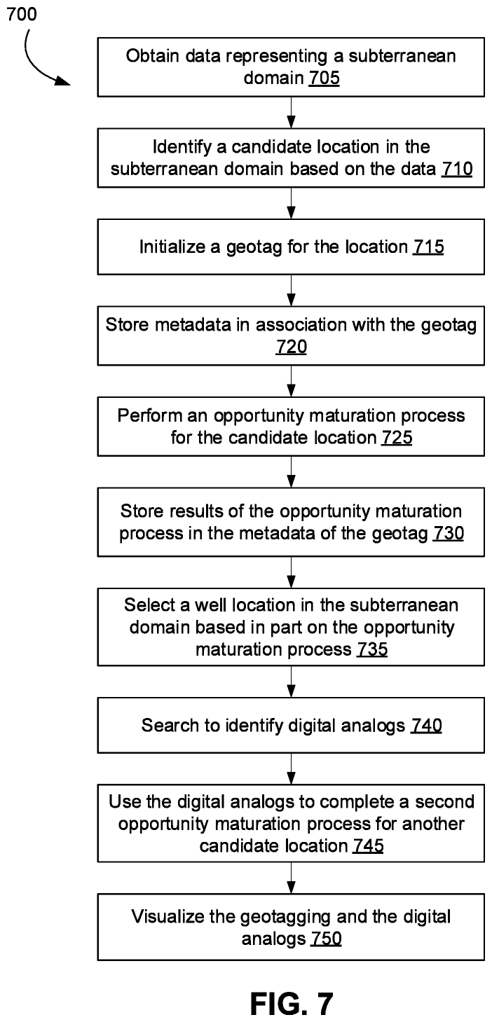

FIG. 7 illustrates a flowchart of a method 700, according to an embodiment. The method 700 may integrate the opportunity maturation process with the storage and rapid, distributed availability of geotags that identify regions, features, reservoirs, etc., in a subterranean domain, so as to facilitate the selection of well sites, inform drilling decisions, etc. The method 700 may include obtaining data representing a subterranean domain, as at 705. The data may be any type of data representing the subterranean domain, including well logs, seismic data, radar, LiDAR, geologic data, core samples, etc. In some embodiments, the first data may be visualized in a three-dimensional map, or in a four-dimensional map that changes with time; however, in other embodiments, the first data may be non-image based.

The method 700 may also include identifying a candidate location in the subterranean domain based on the data, as at 710. For example, an anomalous spike in a signal, an apparent feature in at a particular depth in a formation, etc., may be examples of features that may be associated with a candidate location. In general, a candidate location may be any location within a subterranean location that may be, at least initially, considered as favorable to including hydrocarbons. In a given region, many candidate locations may be evaluated.

A geotag may be associated with the candidate location (either before or after identifying a location as being a candidate), as at 715. The geotag may be an object in a database or other type of memory, that is able to have data (e.g., metadata) stored in association therewith, such that data stored “in association with” the geotag is readily retrievable by identification of the geotag. Likewise, the geotag may be stored in association with the location in the sense that the location is readily identifiable from the geotag. For example, three-dimensional coordinates may be stored in association with the geotag, and the coordinates may identify a unique location within the first data representing the subterranean domain. In some embodiments, a time dimension may also be stored, in addition to the three-dimensional, spatial coordinates. In still other embodiments, any varying attribute may be stored as a dimension, in addition to the three-dimensional, spatial coordinates.

In addition to the location data, various metadata may be stored in association with the geotag, as at 720. The metadata, which is described in greater detail above, may describe the geotag, the first data at or around the candidate location, or both. For example, the metadata may provide insight into the author of the geotag and/or the first data, previous analysis that have been conducted on the location, opportunity maturation results (described in greater detail below), political climate, economic information, costs to transport hydrocarbons, geological information, nearby drilling results, etc.

The method 700 may also include performing an opportunity maturation process to evaluate the candidate location as a well location, as at 725. This may be a multi-stage process, as described above, and may include, for example, identifying a subset of the candidates and leads, a subset of the leads as prospects, a subset of the prospects as drilling locations, and a subset of the drilling locations as well locations. Further, the opportunity maturation process may extend to production activities and abandonment.

There may be many potential results for the opportunity maturation process for an individual candidate location and associated geotag. For example, local (geological data) may be developed as part of the opportunity maturation process and may form one result thereof, e.g., when identifying a lead from a candidate. The opportunity maturation process may also include a risking analysis for the leads, the risk value resulting therefrom being one potential result when attempting to identify a prospect. The results of an economic analysis of a prospect may be another result, which may be used to identify a drilling location from a prospect, and a drilling decision may be result arising from determining a well location from a potential drilling location. Any or each of these results, if and when they become available, may be stored in association with the geotag of the location for which the opportunity maturation process is applied, e.g., as additional metadata, as at 730.

Eventually, one or more candidates may proceed through the opportunity maturation process to being selected for drilling, completion, and production as a well. This well location selection may be based in part on the opportunity maturation process, as at 735, as non-viable candidates are ruled out during the process. The well may be visualized in image-based data, based on the opportunity maturation process, in order to facilitate users locating and implementing the well at the selected location.

The geotags that are created, along with the metadata that is developed for these locations during the opportunity maturation process may be stored in a database of geotags. The database may be searchable to identify digital analogs, as at 740. A digital analog may be a geotag that was previously created and is associated with a location that is analogous in some salient respect to a candidate location that is presently of interest. The location may be analogous in that it is in the same petroleum system (e.g., basin), has similar geoscience coordinates, similar political climate, similar economics, etc.

The digital analog geotag may thus be employed to inform the opportunity maturation process for a current geotag so as to evaluate a candidate location at any or each point in the opportunity maturation process. For example, a result of the opportunity maturation process in the digital analog geotag may be used as a reference for the same step in the opportunity maturation process in the current geotag. For example, a risking analysis result for an analogous lead location may be used to inform the risking analysis being conducted on the current location. This may reduce an uncertainty of the risking analysis. As such, the result (which may be any of the aforementioned results) of the opportunity maturation process for a digital analog geotag may be used to evaluate a current location.

In an embodiment, various aspects of the geotagging and the opportunity maturation process may be visualized, as at 750. Visualizing may include displaying, on a computer screen, the first data of the subterranean domain with one or more geotags for candidate locations therein. The digital analogs and/or their completeness in the opportunity maturation process may also be visualized. This may allow users (including AI, etc.) to quickly select digital analogs to assist in the opportunity maturation process.

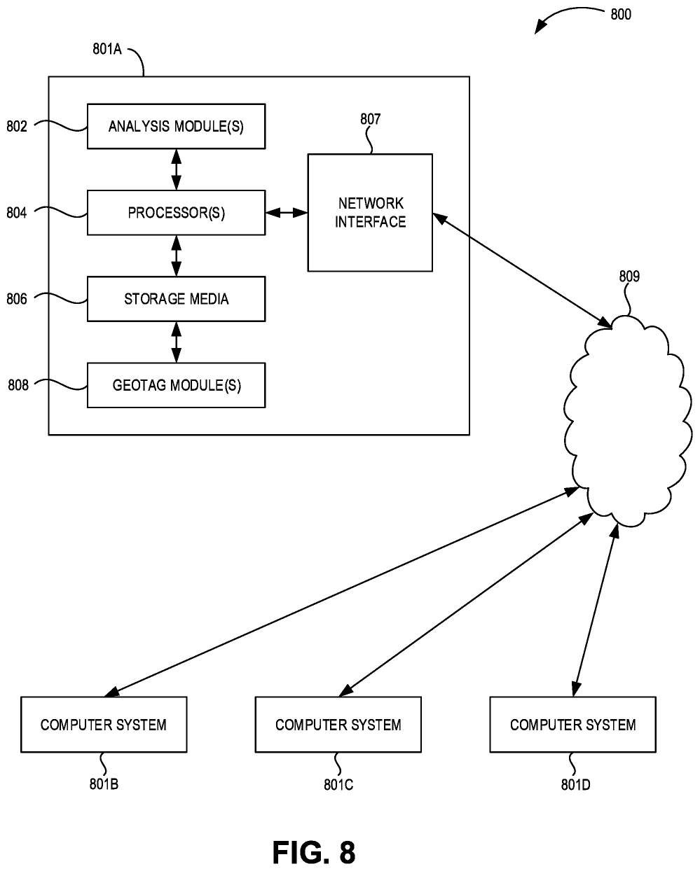

In some embodiments, any of the methods of the present disclosure may be executed by a computing system. FIG. 8 illustrates an example of such a computing system 800, in accordance with some embodiments. The computing system 800 may include a computer or computer system 801A, which may be an individual computer system 801A or an arrangement of distributed computer systems. The computer system 801A includes one or more analysis module(s) 802 configured to perform various tasks according to some embodiments, such as one or more methods disclosed herein. To perform these various tasks, the analysis module 802 executes independently, or in coordination with, one or more processors 804, which is (or are) connected to one or more storage media 806. The processor(s) 804 is (or are) also connected to a network interface 807 to allow the computer system 801A to communicate over a data network 809 with one or more additional computer systems and/or computing systems, such as 801B, 801C, and/or 801D (note that computer systems 801B, 801C and/or 801D may or may not share the same architecture as computer system 801A, and may be located in different physical locations, e.g., computer systems 801A and 801B may be located in a processing facility, while in communication with one or more computer systems such as 801C and/or 801D that are located in one or more data centers, and/or located in varying countries on different continents).

A processor can include a microprocessor, microcontroller, processor module or subsystem, programmable integrated circuit, programmable gate array, or another control or computing device.

The storage media 806 can be implemented as one or more computer-readable or machine-readable storage media. Note that while in the example embodiment of FIG. 8 storage media 806 is depicted as within computer system 801A, in some embodiments, storage media 806 may be distributed within and/or across multiple internal and/or external enclosures of computing system 801A and/or additional computing systems. Storage media 806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

In some embodiments, computing system 800 contains one or more geotag module(s) 808. In the example of computing system 800, computer system 801A includes the geotag module 808. In some embodiments, a geotag module 808 may be used to perform some or all aspects of one or more embodiments of the methods. In alternate embodiments, a plurality of geotag modules 808 may be used to perform some or all aspects of methods.

It should be appreciated that computing system 800 is only one example of a computing system, and that computing system 800 may have more or fewer components than shown, may combine additional components not depicted in the example embodiment of FIG. 8, and/or computing system 800 may have a different configuration or arrangement of the components depicted in FIG. 8. The various components shown in FIG. 8 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the disclosure.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 800, FIG. 8), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

What is claimed is:

1. A method, comprising:
obtaining data representing a subterranean domain;
identifying a candidate location in the subterranean domain based on the data;
creating a geotag associated with the candidate location;
storing metadata in association with the geotag, wherein the metadata describes the geotag, the data at or around the location, or both;
performing an opportunity maturation process to evaluate the candidate location for selection as a well location;
storing a result of the opportunity maturation process as additional metadata associated with the geotag; and
selecting the candidate location as the well location based in part on the opportunity maturation process.

2. The method of claim 1, wherein performing the opportunity maturation process comprises:
searching a database of geotags to identify a digital analog geotag associated with a location that is analogous to the candidate location;
identifying a result of the opportunity maturation process in the digital analog geotag; and
using the result of the opportunity maturation process in the digital analog geotag to perform the opportunity maturation process to evaluate the candidate location.

3. The method of claim 1, wherein performing the opportunity maturation process comprises determining that the candidate location is a lead based on local data, wherein the local data is stored as geological metadata in association with the geotag.

4. The method of claim 3, wherein performing the opportunity maturation process further comprises determining that the lead is a prospect based on a risking analysis, and wherein a result of the risking analysis is stored in association with the geotag.

5. The method of claim 4, wherein performing the opportunity maturation process further comprises determining that the prospect is a drilling location based on an economic analysis, and wherein a result of the economic analysis is stored in association with the geotag.

6. The method of claim 5, wherein performing the opportunity maturation process further comprises determining that the drilling location is a well location based on a drilling decision, and wherein a result of the drilling decision is stored in association with the geotag.

7. The method of claim 6, wherein the geotag comprises a first geotag, the method further comprising performing a second opportunity maturation process for a second candidate location associated with a second geotag based at least in part on the metadata stored in association with the first geotag.

8. The method of claim 1, further comprising visualizing the geotag in the data representing the subterranean domain, and visualizing one or more digital analog geotags that are identified in the data so as to facilitate performing the opportunity maturation process.

9. A computer system, comprising:
one or more processors; and
a memory system comprising one or more non-transitory computer-readable media storing instructions that, when executed by at least one of the one or more processors, cause the computer system to perform operations, the operations comprising:
obtaining data representing a subterranean domain;
identifying a candidate location in the subterranean domain based on the data;
creating a geotag associated with the candidate location;
storing metadata in association with the geotag, wherein the metadata describes the geotag, the data at or around the location, or both;
performing an opportunity maturation process to evaluate the candidate location for selection as a well location;
storing a result of the opportunity maturation process as additional metadata associated with the geotag; and
selecting the candidate location as the well location based in part on the opportunity maturation process.

10. The system of claim 9, wherein performing the opportunity maturation process comprises:
searching a database of geotags to identify a digital analog geotag associated with a location that is analogous to the candidate location;
identifying a result of the opportunity maturation process in the digital analog geotag; and
using the result of the opportunity maturation process in the digital analog geotag to perform the opportunity maturation process to evaluate the candidate location.

11. The system of claim 9, wherein performing the opportunity maturation process comprises determining that the candidate location is a lead based on local data, wherein the local data is stored as geological metadata in association with the geotag.

12. The system of claim 11, wherein performing the opportunity maturation process further comprises determining that the lead is a prospect based on a risking analysis, and wherein a result of the risking analysis is stored in association with the geotag.

13. The system of claim 12, wherein performing the opportunity maturation process further comprises determining that the prospect is a drilling location based on an economic analysis, and wherein a result of the economic analysis is stored in association with the geotag.

14. The system of claim 13, wherein performing the opportunity maturation process further comprises determining that the drilling location is a well location based on a drilling decision, and wherein a result of the drilling decision is stored in association with the geotag.

15. The system of claim 14, wherein the geotag comprises a first geotag, the operations further comprising performing a second opportunity maturation process for a second candidate location associated with a second geotag based at least in part on the metadata stored in association with the first geotag.

16. The system of claim 9, wherein the operations further comprise visualizing the geotag in data representing the subterranean domain, and visualizing one or more digital analog geotags that are identified in the data so as to facilitate performing the opportunity maturation process.

17. A non-transitory computer-readable medium storing instructions that, when executed by at least one processor of a computing system, cause the computer system to perform operations, the operations comprising:
obtaining data representing a subterranean domain;
identifying a candidate location in the subterranean domain based on the data;
creating a geotag associated with the candidate location;
storing metadata in association with the geotag, wherein the metadata describes the geotag, the data at or around the location, or both;
performing an opportunity maturation process to evaluate the candidate location for selection as a well location;
storing a result of the opportunity maturation process as additional metadata associated with the geotag; and
selecting the candidate location as the well location based in part on the opportunity maturation process.

18. The medium of claim 17, wherein performing the opportunity maturation process comprises:
searching a database of geotags to identify a digital analog geotag associated with a location that is analogous to the candidate location;
identifying a result of the opportunity maturation process in the digital analog geotag; and
using the result of the opportunity maturation process in the digital analog geotag to perform the opportunity maturation process to evaluate the candidate location.

19. The medium of claim 17, wherein performing the opportunity maturation process comprises:
determining that the candidate location is a lead based on local data, wherein the local data is stored as geological metadata in association with the geotag;
determining that the lead is a prospect based on a risking analysis, and wherein a result of the risking analysis is stored in association with the geotag;
determining that the prospect is a drilling location based on an economic analysis, and wherein a result of the economic analysis is stored in association with the geotag; and
determining that the drilling location is a well location based on a drilling decision, and wherein a result of the drilling decision is stored in association with the geotag.

20. The medium of claim 17, wherein the geotag comprises a first geotag, the operations further comprising performing a second opportunity maturation process for a second candidate location associated with a second geotag based at least in part on the metadata stored in association with the first geotag.
